(19) United States
(12) Patent Application Publication
(10) Pub. No.: US 2003/0178743 A1
(43) Pub. Date: Sep. 25, 2003

(54) Composite mold for plastic rotational molding

(76) Inventor: Yogesh Manubhai Vakharia, Iowa City, IA (US)

Correspondence Address: YOGESH M. VAKHARIA, 624 WESTWINDS DRIVE, IOWA CITY, IA, 52246, US

(21) Appl. No.: 10/388,068

(22) Filed: Mar. 13, 2003

Related U.S. Application Data
(60) Provisional application No. 60/367,113, filed on Mar. 25, 2002.

(51) Int. Cl. B29C 33/40

(52) U.S. Cl. 264/219

(57) ABSTRACT

Process of making composite molds for plastic rotational molding having perforation (holes) on the mold wall filled or covered with heat conductive material and a heat conductive inner layer.

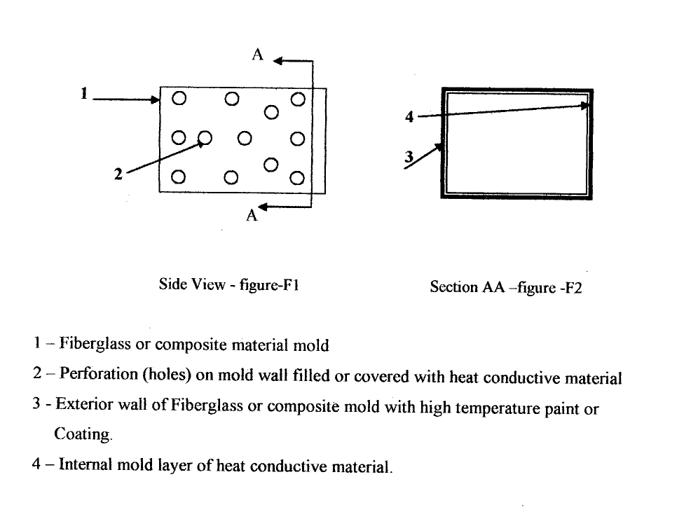

Applicant claims priority of U.S. provisional patent application No. 60/367,113 filing date Mar. 25, 2003

### CROSS REFERENCE TO THE RELATED APPLICATION

Not applicable

### STATEMENT REGARDING FEDERAL SPONSORED R&D

Not Applicable

### REFERENCE OF SEQUENCE LISTING

Not applicable

### BACKGROUND OF INVENTION

Composite molds are tried and probably used for rotational molding prototype or developmental parts with very limited results. This is because composite molds as a whole have poor thermal conductivity compared to conventional metal molds. Generally composite molds are made by hand-lay up process using a pattern master or sample part. Making molds by hand lay-up process lead to uneven wall thickness of the mold especially higher thickness at corners, radius, undercuts and flanges and such areas becomes even much poor heat conductive compared to other areas of the composite molds, Thus Poor and uneven heat transfer of composite mold not only leads to very long heating and cooling cycle but generally results in to a bad molded part as plastic is not formed specially to areas with bad heat transfer. Use of composite material like fiberglass resin or epoxy resins with heat conductive fillers have a limited effect on over all performance of the composite mold for rotational molding application.

### BRIEF DESCRIPTION OF INVENTION

Composite molds for plastic rotational molding with perforation (holes) on the mold wall filled or covered with heat conductive material and a heat conductive inner layer allow faster and better heat transfer. Heat conducts faster through perforation (holes) filled or partially covered with thermally conductive material in mold wall and disperses better through uniform heat conductive inner layer leading to faster molding cycle and better molded parts compared to composite mold without perforation and conductive inner layer.

### BRIEF DESCRIPTION OF DRAWING

Side view of composite mold—FIG.—F1

Sectional view AA of composite mold—FIG. F2

### DETAILED DESCRIPTION OF INVENTION

Fiberglass or epoxy resins with or with out thermally conductive fillers but with flame retardants are used with fiberglass chop, mat or cloth. Mold is made using a pattern generally by hand lay-up method. After the mold is made perforation (holes) are made in the mold wall (FIG. F1 of drawing). Close perforation (more holes) is made at areas of the mold with more thickness or potentially poor heat transfer areas compared to other areas of the mold. Mold is than heat treated. Holes or perforations are either filled with heat conductive material or covered with heat conductive material from inside of the mold. Any excess material removed and mold is cleaned from inside. A thermally conductive layer is applied uniformly inside the mold (FIG. F2 of drawing). Inner layer is allowed to cure. Mold is painted or coated with high temperature paint or coating from outside. Mold once ready can be charged with plastic material and part can be molded using any oven type rotational molding machine.

What I claim as my invention is:

1. A process of making Composite molds for plastic rotational molding having perforation (holes) on the mold wall filled or covered with heat conductive material and a heat conductive inner layer.
